(19) United States
(12) Patent Application Publication
(10) Pub. No.: US 2013/0097039 A1
(43) Pub. Date: Apr. 18, 2013

(54) Circulation Control Strategies For Tangible Media

(71) Applicant: Central Technology, Inc., Avon, IN (US)

(72) Inventor: Kenneth R. Czapla, Sullivan, IN (US)

(73) Assignee: Central Technology, Inc., Avon, IN (US)

(21) Appl. No.: 13/653,855

(22) Filed: Oct. 17, 2012

Related U.S. Application Data
(60) Provisional application No. 61/548,475, filed on Oct. 18, 2011.

(51) Int. Cl. G06Q 20/20

(52) U.S. Cl. 705/21; 705/16

(57) ABSTRACT

Circulation control of tangible media materials may include transmitting an authorization request from a self-checkout station for a checkout transaction. A signal may be received at the self-checkout station indicative of a fault generated in response to the authorization request, and a handheld control device may be used to command assignment of a pseudo-identifier to the checkout transaction such that the article of tangible media can be released to circulation via the self-checkout station. Related hardware and control logic is also disclosed.

### CROSS REFERENCE TO RELATED APPLICATION

This Patent Application claims the benefit of the filing date of U.S. Provisional Patent Application Ser. No. 61/548,475, filed Oct. 18, 2011.

### TECHNICAL FIELD

The present disclosure relates generally to systems and strategies for controlling the circulation of tangible media materials, and relates more particularly to assigning a pseudo-identifier to a checkout transaction to enable releasing an article of tangible media to circulation.

### BACKGROUND

Self-checkout systems have been around for decades in the library environment. This technology has provided a convenience to the library patron, as well as providing a time and cost savings for libraries. This self-service technology provides the ability for a patron to check out their own library materials without the help of a staff member. While this technology added a fast and convenient way for a patron to expedite their checkout experience, it has proven itself limited in many ways in the event a problem arises during a session at the self-checkout station.

An example of these limitations would be that the self-checkout station might block a patron from using the self-checkout because of an account discrepancy. A patron might be blocked as a result of having an expired card, or excessive fee/fines, overdue items, among other reasons. These conditions prohibit the patron from using the self-checkout system. As a result, the patron is instructed by the self-checkout system to go to the circulation desk for assistance.

Another example is when an item is blocked from checking out. Typically this is due to an item that has a hold placed on it by another patron. Other examples are if a patron has reached their checkout limits set by the library, age verification is needed or a staff member is required to verify that all of the pieces are present for multi-piece kits. These sorts of blocked item conditions require a patron to take the item to the circulation desk to be dealt with by a staff member. Action such as an override at the circulation desk is labor-intensive, and disruptive to the smooth and efficient operation of the library.

Recent years have seen a substantial increase in the number of self-checkout stations libraries have installed at their facilities. This may compound the problems described above, and can even cause inconvenience to multiple patrons simultaneously, having to each gather all of their belongings and go to the circulation desk. In some cases, this is done merely to have a single item that would not check out at the self-checkout station be checked out by a staff member. Self-checkout systems' inability to deal with and correct problems can result in long lines at the circulation desk, and cause a staff member at the circulation desk to be overwhelmed by frustrated patrons.

A variety of different systems and strategies for handling these and related problems have been proposed. One example of this is that in the event a problem occurred at a self-checkout station, a staff workstation receives a pop-up message from the self-checkout station. This proved to be inefficient because the staff member quite often is unable to take any action, nor remedy the issue, at the self-checkout station itself, and a visit to the circulation desk is still required. In sum, merely notifying staff of a problem does not enable efficiently correcting it. Certain other systems attempt to enable library staff to correct problems directly on a library's server from an auxiliary device provided in addition to self-checkout stations, but tend to be unwieldy and/or unreliable.

### SUMMARY

The present disclosure introduces a wireless mobile device, methodology, and control logic, for receiving messages, alerts and status conditions from one of many self-checkout stations in real time, and proposes a strategy contemplated to obviate the need for staff intervention at a circulation desk or other supervisory, fixed location.

A designated staff attendant may use such a mobile device and would be alerted to any problems from a self-checkout station. The staff attendant will have the ability to take quick action, and send commands back to the self-checkout station to alleviate problems. The wireless mobile device also enables the staff attendant the freedom to roam and approach a self-checkout station to help patrons through the one or more transactions in a checkout session if required. This method eliminates the need for a patron to leave the self-checkout station in the event they have a problem.

In one aspect, a method of controlling circulation of tangible media materials includes transmitting an authorization request from a self-checkout station for a checkout transaction, the authorization request encoding at least one of a patron identifier and a media identifier. The method further includes receiving a signal at the self-checkout station indicative of a fault generated in response to the authorization request. The method further includes commanding assignment of a pseudo-identifier to the checkout transaction, such that the article of tangible media can be released to circulation via the self-checkout station.

In another aspect, a system for controlling circulation of tangible media materials includes a self-checkout station having at least one reader configured to read each of a media identifier for an article of tangible media to be checked out by a patron, and a patron identifier for the patron. The self-checkout station further includes a transmitter, a receiver, and a computer in communication with the at least one reader, the transmitter, and the receiver. The computer is configured to receive data from the at least one reader indicative of at least one of the media identifier and the patron identifier, and responsively transmit an authorization request via the transmitter to a server, for a checkout transaction at the self-checkout station. The computer is further configured to receive a signal from the server indicative of a fault generated in response to the authorization request. The system further includes a control device in communication with the self-checkout station and being configured to command assignment of a pseudo-identifier to the checkout transaction to override the fault, such that the article of tangible media can be released to circulation via the self-checkout station.

In still another aspect, a self-checkout station for controlling circulation of tangible media materials includes at least one reader configured to read a media identifier for an article of tangible media to be checked out by a patron, and a patron identifier for the patron. The self-checkout station further includes a transmitter, a receiver, and a computer in communication with the at least one reader, the transmitter, and the receiver. The computer is configured to receive data from the at least one reader indicative of at least one of the media identifier, and the patron identifier, and responsively transmit an authorization request via the transmitter to a server for a checkout transaction at the self-checkout station. The computer is further configured to receive a signal from the server indicative of a fault generated in response to the authorization request, and to assign a pseudo-identifier to the checkout transaction to override the fault, such that the article of tangible media can be released to circulation.

### BRIEF DESCRIPTION OF THE DRAWINGS

FIG. 1 is a block diagram of a system, according to one embodiment;

FIG. 2 is a flowchart illustrating part of a process, according to one embodiment;

FIG. 3 is another flowchart illustrating additional parts of the process;

FIG. 4 is a diagramatic view showing example screenshots on a control device, according to one embodiment; and

FIG. 5 is a diagramatic view showing additional example screenshots on the control device.

### DETAILED DESCRIPTION

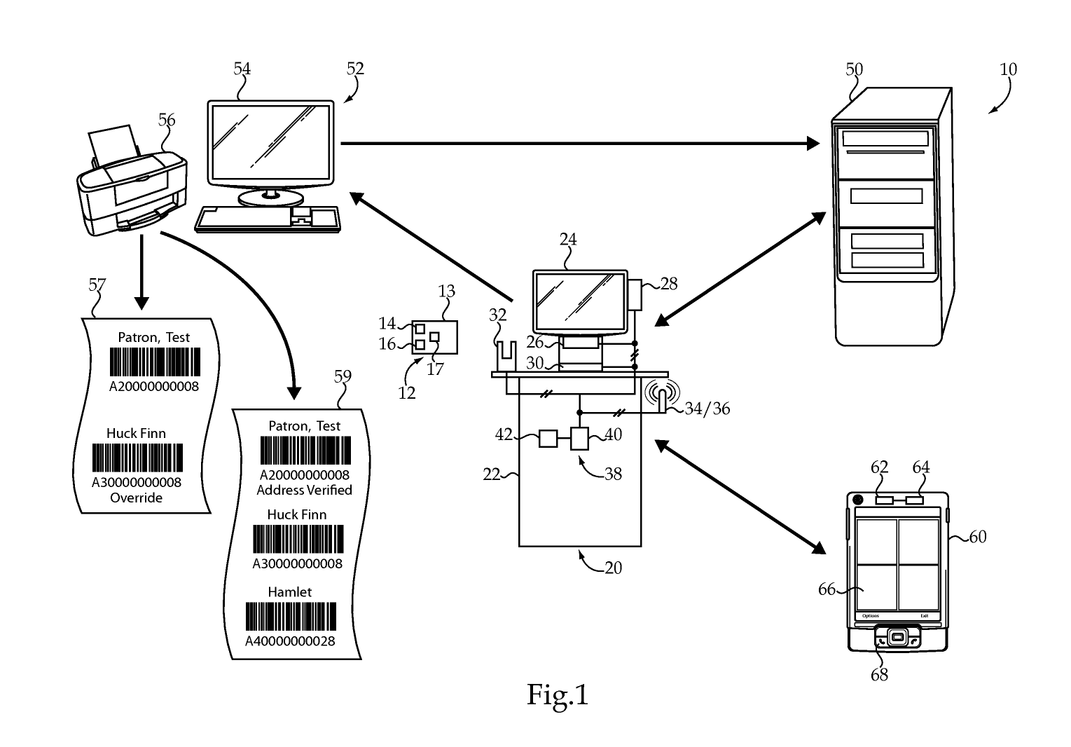

Referring to FIG. 1, there is shown a system 10 for controlling circulation of tangible media materials. As used herein, the term “tangible media material” includes media materials such as books, cd's dvd's, audio or video tapes, computer disks, magazines, and virtually any item commonly available for checkout from a library or similar lending institution. Such media materials may be securable, being equipped with one or more resident electronic or magnetic security devices, for example, which each include at least two different security states such as an enabled or armed state, and a disabled or disarmed state. In FIG. 1, an article of tangible media 12 is shown, and has a case 13, a magnetic security device 14, an electronic security device 16, and an ID tag 17. Article 12 may also include a disk, tape, or other electronic or magnetic information storage device housed within case 13, but instead may include an unpackaged book, magazine, etc. As will be further apparent from the following description, system 10 is adapted to enable a patron to leave the institution with article 12 where release of article 12 to circulation would otherwise be problematic, and does so in a manner more efficient than typical strategies.

System 10 further includes a self-checkout station 20 including a housing 22 and a computer display 24 configured to display various information to a patron during a checkout transaction. Display 24 may be configured as a touch screen interface to receive inputs from the patron during a checkout transaction as well. Station 20 also includes at least one reader configured to read each of a media identifier for an article of tangible media to be checked out by a patron, and a patron identifier for the patron. As noted above, article 12 may include an ID tag 17, such as an RFID tag, and the at least one reader may be configured to read the stored media identifier from ID tag 17. In one practical implementation strategy, station 20 includes a first reader 26 configured to read the media identifier, and a second reader 28 configured to read the patron identifier, such as a patron identifier number or code stored on a magnetic stripe of a library card. Where the patron's card includes a bar code or the like, the same reader/scanner might be used to read both the media and patron identifiers. Station 20 may further include an electronic security disabling mechanism 30, configured for example to flip a security bit stored on device 16 in a conventional manner, and a mechanical security disabling mechanism 32 configured to switch device 14 from a locked state to an unlocked state. Device 14 may include a magnetic lock for case 13 in certain embodiments. In one practical implementation strategy, mechanisms 30 and 32 may be of the types disclosed in co-pending and commonly owned U.S. patent application Ser. No. 12/83,362, now U.S. Pat. No. ______.

Station 20 further includes a transmitter 34, a receiver 36, and a computer 38 in communication with readers 26 and 28, transmitter 34, and receiver 36. In the embodiment shown, a transmitter-receiver 34/36 is employed, capable of transmitting and receiving wireless communication signals, however, in other embodiments a separate transmitter and a separate receiver might be used. Wired communication might also be employed for at least some of the functions of system 10 contemplated herein. Moreover, computer 38 might itself be understood to be a transmitter and a receiver, as the functions described herein of “transmitting” and “receiving” data, signals, etc., can be carried out by a computer attached to a wired communication network.

Computer 38 is configured to receive data from readers 26 and 28 indicative of the media identifier, and data indicative of the patron identifier, respectively. Computer 38 includes a processer 40 and a memory 42, and during a checkout transaction for an article of tangible media, may at least briefly store a media identification number and a patron identification number so received on memory 42. Memory 42 may also store computer readable code which, upon execution by processor 40, enables performing the various control functions of station 20 discussed herein. Responsive to the data from at least one of the readers 26 and 28, computer 38 may output an authorization request via transmitter 34 to server 50 for a checkout transaction at station 20. The request may encode at least one of a patron identifier, e.g. a number, and a media identifier, e.g. also a number. In a practical implementation strategy, computer 38 may transmit the request in the form of a signal to server 50, which is located remotely from station 20, and other self-checkout stations typically used at the institution. The request might be transmitted wirelessly or via a wired communication network. Server 50 may include a conventional Integrated Library System (ILS) database storing patron status information such as blocked or not blocked, and media status information such as on-hold, age restricted, not available for checkout, available, or other information. Server 50 may receive the authorization request and determine whether a problem exists with respect to the patron, with respect to the article of media 12, or both, via querying the ILS database. These different conditions of blocked, unblocked, and others, representing potential problems in checking out with respect to either or both of the patron or the article of media are further discussed herein. Where a problem does exist, server 50 may generate a fault responsive to the request, and output a signal to station 20 indicative of the fault. Communications between server 50 and station 20 may occur according to the well-known SIP2 electronic communication protocol, via a conventional SIP2 interface.

System 10 may further include a control device 60 having a transmitter-receiver 62, a computer 64, a display 66 comprising a touchscreen user interface, and a button interface 68. Control device 60 may also include an on-board laser scanner, for use in scanning bulky or oversized materials, for example, that the patron finds difficult to scan themselves. Control device 60 may be a mobile handheld control device in wireless communication with station 20, and configured to command assignment of a pseudo-identifier to the checkout transaction to override the fault, such that the article of tangible media can be released to circulation via station 20.

As noted above, there can be a number of instances where a patron attempts to check out an article of media, but is blocked because of an issue with the patron's status at the institution, with the article of tangible media sought to be checked out, or because of an issue matching a patron with a particular article. In certain instances, station 20 may communicate with server 50 with regard to each of these conditions, patron status, article status, and patron matched with article. Control device 60 enables a staff member to quickly and locally override a fault generated in these and other situations. The pseudo-identifier may be a pseudo-patron or guest identifier, or a pseudo-article identifier in other instances. In any case, the pseudo-identifier may be or include a numerical code. In a practical implementation strategy, the pseudo-identifier may be stored on computer readable memory 42.

Upon receipt of the signal indicative of the fault, station 20 may transmit an alert to control device 60 to notify a staff member that a problem exists which may need to be corrected. Communication between control device 60 and station 20 may be according to a second electronic communication protocol, different from SIP2, such as wireless 802.1/a/b/g, or any other suitable proprietary or non-proprietary protocol. Once the alert is sent to the control device, station 20 may be placed in a suspense mode, along with a screen display presented to the patron that might say, for example, “Please wait, attendant has been notified”. Station 20 may then wait until it receives a command back from control device 60. Rather than a mobile handheld device, the staff attendant's activities could be performed at a stationary computer workstation. Control device 60 may display a prompt on display 66 in response to the alert, or in response to a staff member's action on the alert, enabling the staff member to take action to override the fault, as discussed herein. In the suspense mode, mechanisms 30 and 32 may not be operable, but can then be enabled to allow disabling/unlocking of devices 14 and 16 in response to the commanded assignment of the pseudo-identifier. Control device 60 can also send an “end session” command, in case a patron forgets to properly end their session. At any time, the control device 60 can also display station activity, including:
In use, or not in use;
Patron record of patron currently using the self-checkout station;
Running list of items currently checked out by the patron.

System 10 may further include a supervisory computer station 52 including a computer 54 running the institution's automation hardware and a dedicated receipt printer 56. Computer 38 may be configured to transmit an electronic transaction report in response to the assignment of the pseudo-identifier to station 52, and encoding other information as further described herein. A staff member working at station 52 can utilize the information in the electronic transaction report to formally update records on server 50 as time allows. In a practical implementation strategy, printer 56 may print a receipt in response to every electronic transaction report received, and thus the mere presence of a receipt at printer 52 is indicative of at least one overridden transaction. As alluded to above, such features enable a patron to leave the institution with their materials released to circulation without the need to manually and presently update the database on server 50 or visit the circulation desk. In other words, where a problem is encountered in attempting to checkout media materials, rather than attempting to fix the problem at server 50, system 10 enables the problem to be bypassed to keep patrons moving through the checkout process, and such that formal updating of the database and correcting of the problem can take place at the convenience of the institution's staff.

Also shown in FIG. 1 are a first receipt 57 and a second receipt 59 representing electronic transaction reports for a first transaction (receipt 57) where a block on an article of media, such as the book Huckleberry Finn is overridden, and a second transaction (receipt 59) where a block on a patron is overridden. On receipt 57, the patron's name “test” is shown, along with a bar code and number associated with the patron's account. In addition, the title of the article, bar code, and number, are also printed on receipt 57, along with the word “override,” which could automatically be encoded in the corresponding electronic transaction report, or entered as a text message by a staff member wielding control device 60. It should be appreciated that the ILS database has not been updated until action is taken to do so by a staff member, yet the article(s) are released to circulation. Receipt 59 includes analogous information, but represents an overridden fault relating to a blocked patron. To this end, receipt 59 includes a text message “address verified,” representing an example step taken by the staff member to override a fault generated where the patron was blocked. Again, the ILS database is not yet updated. Another way to understand what is represented by receipts 57 and 59, is that in both cases a fault was generated in response to an authorization request as described herein. In the case of receipt 57, the fault may have been due to a hold on the article, for example, overridden because the patron who placed the hold was in fact the patron attempting to check out the article. Alternatively, the fault may have been overridden because the hold was discovered to be in error, because the ILS database mistakenly indicated that the article was not at the library, or for a host of still other reasons. In the case of receipt 59, the fault may have been due to incomplete patron information on the ILS database, or information needing verification due simply to the passage of time, for example, since the last time the patron checked anything out, or for still other reasons. In either case, receipts 57 and 59 provide an indication that an override occurred, and that the ILS records need to be updated. The receipt can then be scanned directly by a staff member electronically or simply read manually, and the ILS database updated.

### INDUSTRIAL APPLICABILITY

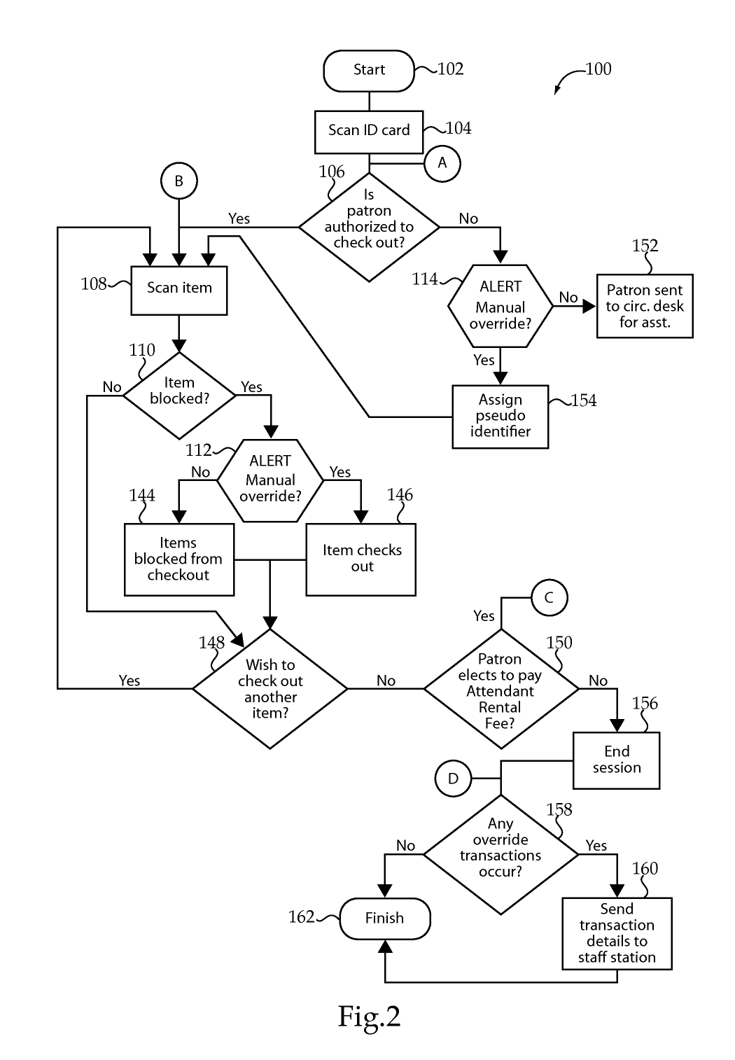

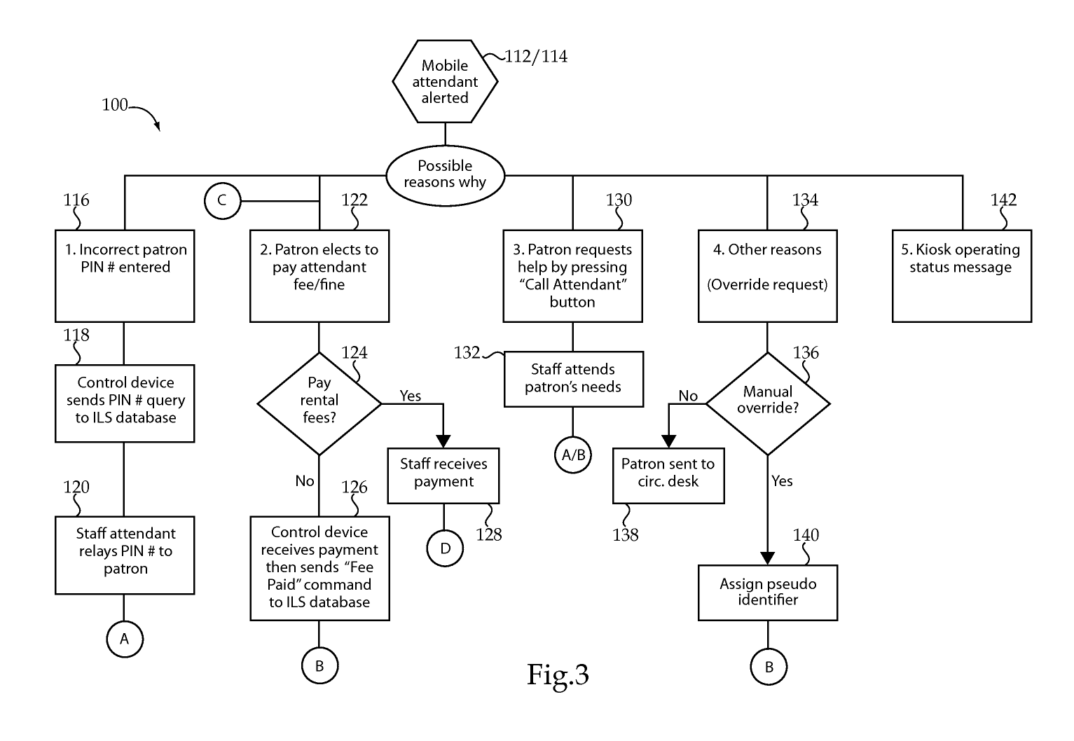

Referring now to FIGS. 2 and 3, there is shown an example process according to the present disclosure, beginning at step 102, and proceeding to step 104 where a patron's ID card is scanned at station 20. From step 104, the process may proceed to step 106 to query whether the patron is authorized to check out, for example, by transmitting an authorization request from station 20 to server 50. If no, the process may proceed to step 114. If yes, the process may proceed to step 108 to scan an item, such as an article of tangible media as described herein, at station 20. From step 108, the process may proceed to step 110 to query whether the item is blocked, again by transmitting an authorization request. If no, it is assumed that the item can be successfully checked out and the process proceeds to step 148 to query whether the patron wishes to check out another item. In some cases, between steps 110 and 148, or as part of step 110, station 20 may transmit another request as to whether the item can be matched for checkout with the patron, and receive either a fault signal, an authorization signal, or no signal-indicating no problem exists. If the item is blocked at step 110, a fault is generated and the process may process to step 112.

FIG. 3 shows example processes that may occur at either of steps 112 or 114. At step 112, control device 60 can receive an alert from station 20, that an item is blocked for instance. At step 114, control device 60 may receive an alert from station 20 that a patron is blocked, for instance. In response to the alert, a staff member wielding control device 60 can determine not to perform a manual override, in which case the process would proceed from step 112 to step 144 where the items are blocked from checkout. If the staff member decides not to perform a manual override at step 114, the process can proceed to step 152 where the patron is sent to the circulation desk for assistance. If in either case the staff member decides to perform a manual override, further procedures set forth in FIG. 3 may be followed.

As also depicted in FIG. 3, one of the reasons for a manual override might be that a patron's incorrect personal identification number (PIN) has been entered, step 116. If this is the case, the process may proceed to step 118 where control device 60 can send a PIN number query to the ILS database at server 50. At this step, control device 60 may simply read the stored PIN, and thus need not communicate via the SIP2 protocol with the ILS database on server 50. From step 118, the process may proceed to step 120 where the staff member relays the correct PIN to the patron. The process may then return to again query whether the patron is authorized to checkout at step 106. Another possible reason why the alert is generated may be where the patron elects to pay the attendant a fee or a fine, step 122. Step 122 may be reached following step 148 as shown in FIG. 2. From step 122, the process may proceed to step 124 to query how the patron is paying the rental fees. The process may proceed from step 124 to step 128 where the staff member is paid directly, or may proceed to step 126 where control device 60 receives payment, such as electronically by reading a credit card stripe, and then sends a fee paid command or the like to the ILS database at server 50. From step 126, the process may proceed to step 108. From step 128, the process may proceed to step 158. In the case of fee payments, control device 60 may utilize the SIP2 protocol to communicate directly with server 50.

Steps 130 and 132 illustrate a patron request for help by pressing a call attendant button or the like at station 20, followed by the staff member attending the patron's needs. The requested assistance might be scanning a bulky or multi-piece item, or some other form of assistance. Other possible reasons an alert could be sent to control device 60 is a problem with station 20, such as a software problem or equipment failure, or a receipt printer running out of paper, for instance. At step 142, accordingly, control device 60 may receive a kiosk operating status message, indicating such a problem.

Steps 134-140 illustrate steps in performing a manual override in response to an override request. At step 136, a query is made whether a manual override is to be performed. If no, the patron may be sent to the circulation desk at step 138. If yes, the process may proceed to step 140 in which the staff member commands assignment of a pseudo-identifier for the patron as described herein. From step 140, the process may proceed to step 108. From step 148, the process may proceed to step 150 to query whether the patron elects to pay fees to the staff attendant. If yes, the process may proceed to step 122 as described herein. If no, the process may proceed to step 156 to end the patron's session. From step 156, the process may proceed to step 158 to query whether any override transactions occurred. If no, the process may proceed to finish at step 162. If yes, the process may proceed first to step 160 to generate and transmit an electronic transaction report to station 52, as described herein, and then finish at step 162.

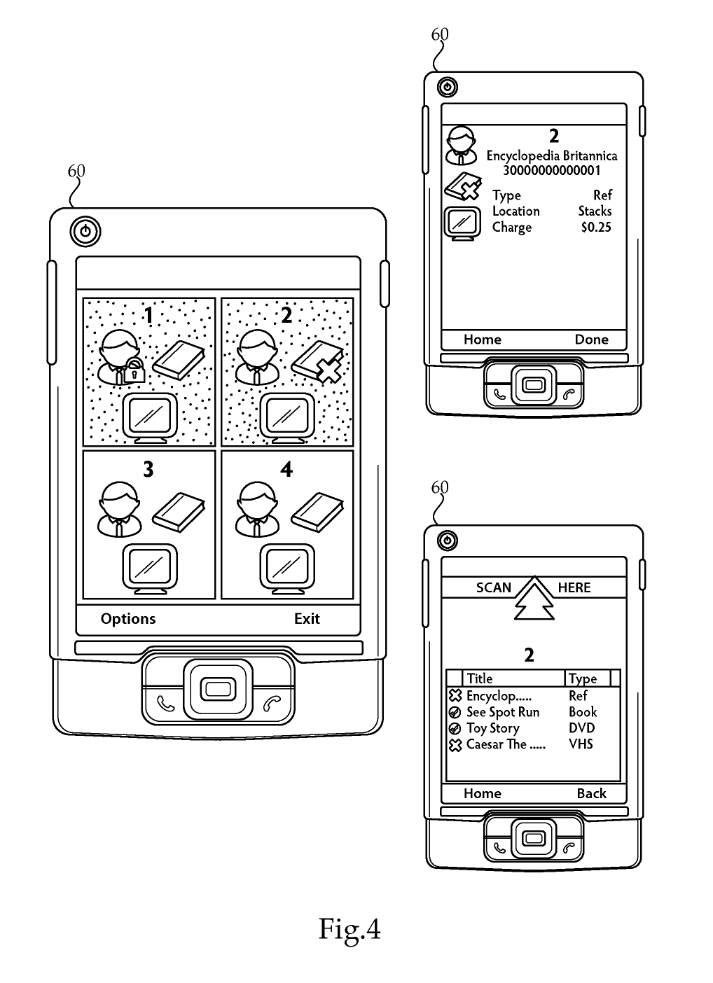

Referring now to FIG. 4, there is shown control device 60 in three different views as it might appear to a staff member monitoring multiple self-checkout stations numbered 1, 2, 3, and 4 in the largest view. At station 1, a patron icon is shown with a padlock symbol, indicating to the staff member that the patron is blocked, that no patron PIN has been entered, or that the patron account has been deactivated, for example. Stations 3 and 4 are idle, or being used by patrons without a problem. Station 2 shows a blocked article via the “X” associated with a book icon. Different background coloring, stippling or the like for stations 1 and 3 on the display indicates a problem or potential problem, and may be understood as an alert as described herein.

The staff member might select station 2, such as by touching the corresponding part of the display screen on control device 60, and be presented with the display shown in the smaller view of control device 60 in the upper right of FIG. 4. At this point, control device 60 may display additional information as to an amount of payment required to checkout the article. The staff member may then touch the display on control device 60, for example the charge amount, and transition to the state shown in the view of control device 60 shown in the lower right of FIG. 4, where control device 60 prompts the staff member to scan the article and receive payment from the patron. Control device 60 may be subsequently used to override the block via a control command to station 20, and enable the release of the article to circulation.

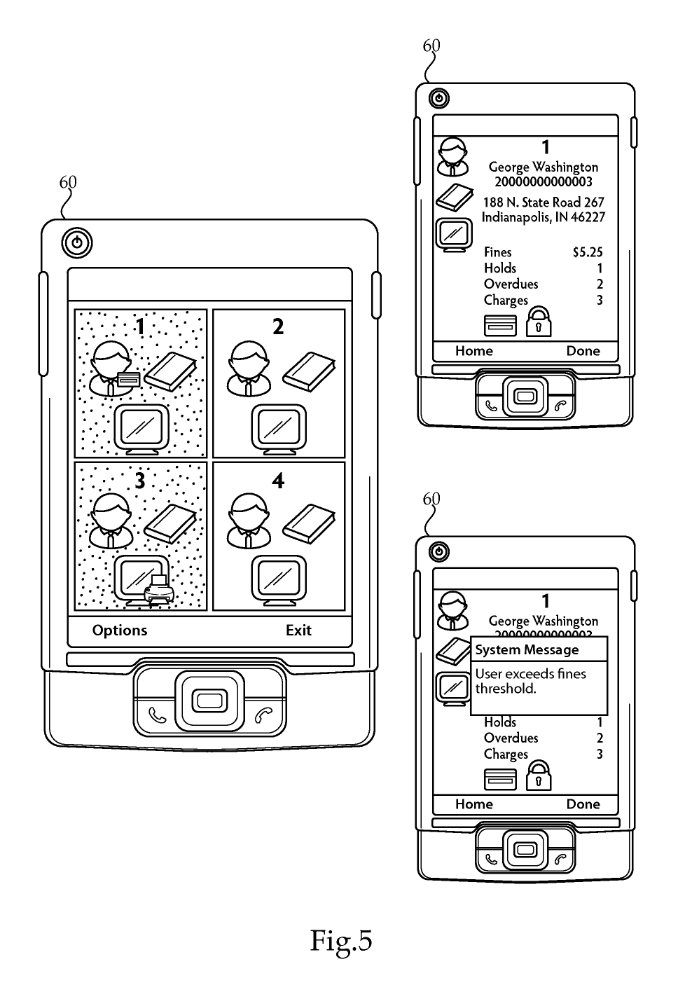

Referring now to FIG. 5, there is shown control device 60 in views analogous to those of FIG. 4, but where a patron is blocked on the basis of outstanding fines. A credit card symbol or the like is displayed an article of media at station 2 is blocked. The staff member may follow steps analogous to those described in connection with FIG. 4 to receive additional information and rectify problems. In particular, the staff member may receive information on control device 60, as shown in the upper right view of control device in FIG. 5, that the patron has outstanding fines, and also the padlock symbol indicating that the patron is blocked from checking out anything. From this point, the staff member could request further information via control device 60, receiving the displayed information as to exceeding a fines threshold shown in the lower right view of control device 60. The staff member could then use control device 60 to command assignment of a pseudo-identifier to the checkout transaction as described herein, such as where the patron chooses to pay the fines directly to the staff member, or could choose not to override the fault and continue to block the patron.

The present description is for illustrative purposes only and should not be construed to narrow the breadth of the present disclosure. Thus, those skilled in the art will appreciate that various modifications might be made to the presently disclosed embodiments without departing from the full and fair scope and spirit of the present disclosure. Other aspects, features and advantages of the present disclosure will be apparent upon an examination of the attached drawings and appended claims.

What is claimed is:

1. A method of controlling circulation of tangible media materials comprising the steps of:
transmitting an authorization request from a self-checkout station for a checkout transaction, the authorization request encoding at least one of a patron identifier and a media identifier;
receiving a signal at the self-checkout station indicative of a fault generated in response to the authorization request; and
commanding assignment of a pseudo-identifier to the checkout transaction, such that the article of tangible media can be released to circulation via the self-checkout station.

2. The method of claim 1 wherein the step of commanding further includes transmitting a control command from a control device to the self-checkout station.

3. The method of claim 2 wherein the step of transmitting further includes transmitting the authorization request according to a first communication protocol, and the step of transmitting the control command includes transmitting the control command according to a second, different communication protocol.

4. The method of claim 2 wherein the step of commanding further includes wirelessly transmitting the control command from a mobile handheld control device.

5. The method of claim 2 further comprising a step of generating the fault via querying a database on a remote server storing patron status information and media status information, responsive to the authorization request.

6. The method of claim 2 further comprising a step of transmitting an electronic transaction report from the self-checkout station indicative of the assignment of the pseudo-identifier.

7. The method of claim 6 wherein the pseudo-identifier includes a pseudo-patron identifier.

8. The method of claim 2 further comprising the steps of transmitting an alert to the control device in response to the signal.

9. The method of claim 8 wherein the step of transmitting the alert includes wirelessly transmitting the alert to a handheld control device.

10. The method of claim 1 further comprising a step of enabling a security disabling mechanism of the self-checkout station in response to the commanded assignment.

11. The method of claim 10 further comprising a step of executing the release of the article of tangible media to circulation via disabling at least one of an electronic security device and a magnetic security device of the article of tangible media via the security disabling mechanism.

12. A system for controlling circulation of tangible media materials comprising:
a self-checkout station including at least one reader configured to read each of a media identifier for an article of tangible media to be checked out by a patron, and a patron identifier for the patron;
the self-checkout station further including a transmitter, a receiver, and a computer in communication with the at least one reader, the transmitter, and the receiver;
the computer being configured to receive data from the at least one reader indicative of at least one of the media identifier and the patron identifier, and responsively transmit an authorization request via the transmitter to a server, for a checkout transaction at the self-checkout station;
the computer being further configured to receive a signal from the server indicative of a fault generated in response to the authorization request; and
a control device in communication with the self-checkout station and being configured to command assignment of a pseudo-identifier to the checkout transaction to override the fault, such that the article of tangible media can be released to circulation via the self-checkout station.

13. The system of claim 12 wherein the self-checkout station further includes at least one security disabling mechanism for executing the release to circulation via disabling a security device of the article of tangible media.

14. The system of claim 13 wherein the control device includes a mobile handheld control device in wireless communication with the self-checkout station.

15. The system of claim 14 wherein the pseudo-identifier includes a pseudo-patron identifier.

16. The system of claim 15 wherein the self-checkout station further includes a computer readable memory storing the pseudo-patron identifier, and the computer is further configured to transmit an electronic transaction report to a supervisory computer station responsive to the assignment of the pseudo-patron identifier.

17. The system of claim 15 wherein the self-checkout station is further configured to transmit an alert to the control device in response to the signal.

18. A self-checkout station for controlling circulation of tangible media materials comprising:
at least one reader configured to read a media identifier for an article of tangible media to be checked out by a patron, and a patron identifier for the patron;
a transmitter;
a receiver; and
a computer in communication with the at least one reader, the transmitter, and the receiver;
the computer being configured to receive data from the at least one reader indicative of at least one of the media identifier and the patron identifier, and responsively transmit an authorization request via the transmitter to a server, for a checkout transaction at the self-checkout station;
the computer being further configured to receive a signal from the server indicative of a fault generated in response to the authorization request, and to assign a pseudo-identifier to the checkout transaction to override the fault, such that the article of tangible media can be released to circulation.

19. The self-checkout station of claim 18 further comprising a computer readable memory storing the pseudo-identifier.

20. The self-checkout station of claim 19 further comprising at least one security disabling mechanism for executing the release to circulation via disabling a security device resident on the article of tangible media, and wherein the computer is in control communication with the at least one security disabling mechanism and configured to enable the security disabling mechanism in response to a commanded assignment of the pseudo-identifier by a remote handheld control device.
